(19) United States
(12) Patent Application Publication
(10) Pub. No.: US 2026/0284551 A1
(43) Pub. Date: Sep. 24, 2026

(54) Continuous Chromatography System

(71) Applicant: The Johns Hopkins University, Baltimore, MD (US)

(72) Inventors: Richard M. Egan, Elkridge, MD (US); Luis T. Tsatsos Montoliu, Bethesda, MD (US); Mallory Solazzo, Baltimore, MD (US); Micah J. Nissly, Severn, MD (US); James K. Johnson, Silver Spring, MD (US); Collin M. Timm, Ellicott City, MD (US)

(73) Assignee: The Johns Hopkins University, Baltimore, MD (US)

(21) Appl. No.: 19/571,064

(22) Filed: Mar. 18, 2026

Related U.S. Application Data
(60) Provisional application No. 63/773,559, filed on Mar. 18, 2025.

(51) Int. Cl. B01D 15/14; B01D 15/20

(52) U.S. Cl. CPC B01D 15/14; B01D 15/203

(57) ABSTRACT

A continuous chromatography system (CCS) utilizes a continuously moving solid phase, which may be a single or unitary element, is provided. The CCS may be configured to define two separate actively wet zones including an enrichment zone where selective separation between two components from a liquid feed stream is achieved, and a desorption or wash zone where the component enriched on the solid phase is removed for collection as an enriched product stream.

### CROSS-REFERENCE TO RELATED APPLICATIONS

This application claims priority to and the benefit under 35 U.S.C. § 119(e) of U.S. Provisional Application Ser. No. 63/773,559, filed on Mar. 18, 2025, the entire content of which is expressly incorporated herein by reference.

### TECHNICAL FIELD

Example embodiments relate generally to chromatography and, more particularly, to a continuous chromatography system (CCS) that utilizes a continuously moving solid phase, which may be a single or unitary element. The CCS may be configured to define two separate actively wet zones, including an enrichment zone where selective separation between two components from a liquid feed stream is achieved, and a desorption or wash zone where the component enriched on the solid phase is removed for collection as an enriched product stream.

### BACKGROUND

Various forms of liquid chromatography for the separation and/or purification of constituents within a feed or sample have been commercially used for many years. One type of liquid chromatography may be referred to as batch chromatography, which as has been used for numerous years. In batch chromatography a column is packed with adsorbent material (e.g., a plurality of resin beads) which is called the stationary phase or sorbent. The stationary phase is determined based on the characteristics of the feed stream. Typical stationary phase used are carbon, silica gel, alumina, modified silica etc. Once the column is packed it is flushed with a mobile phase. Mobile phase may be a single solvent or a mixture of solvents that are decided based on the solute solvent interactions. Similar to analytical chromatography the feed solution is injected into the column and then eluted with the mobile phase called desorbent, which at times have been used interchangeably. The components of the feed that have higher affinity for the sorbent are referred to as having a higher partition coefficient. Having a higher partition coefficient means that the component is strongly bound or attracted to the sorbent, which will develop a higher concentration on the sorbent than in the mobile phase. Since only the components carried via the mobile phase/desorbent migrate with the mobile phase/desorbent, a feed component having a higher affinity for the sorbent migrates slower than a feed component having a lower affinity for the sorbent thereby creating a concentration gradient in the column resulting in separation of the various feed components. Such batch systems and methods, however, tend to suffer from low yield, high solvent consumption, poor column utilization and high product dilution.

In view of the substantial shortcomings associated with batch chromatography, a technology referred to as simulated moving bed (SMB) chromatography was developed. In such systems, the one or more columns are packed with sorbent (e.g., a plurality of resin beads). The columns are coupled in a series configuration to mimic a single large column of sorbent. In such SMB processes, the various input (e.g., feed stream, and desorbent stream) and output streams (e.g., extract, and raffinate) are continuously operated but their respective inlet and outlet locations along the length of the column are modified/changed while the sorbent material remains stationary within the column. In this regard, the respective inlet and outlet locations are changed over given time intervals to mimic a countercurrent flow of the resin bed relative to the input and output streams. Accordingly, movement of the sorbent bed is simulated. SMB processes, however, have been found to be particularly complicated to operate in practice and the varying flow rates within different zones defined between respective liquid inputs and outputs generates pressure swings within the sorbent material that can introduce channeling (e.g., fluid travels through only a portion of the sorbent such that all of the sorbent is not utilized), and destruction of sorbent particles into fines that may be carried with the respective fluids and blind/plug other components of the SMB equipment (e.g., liquid distribution components like DSM screens and laterals).

Thus, there remains a significant and unmet need for a continuous chromatography system that provides for the continuous separation and/or purification of individual components (e.g., analytes) present in a liquid feed stream or source.

### BRIEF SUMMARY

One or more non-limiting, example embodiments solve at least one of the aforementioned problems. Example embodiments provide a substrate which defines a solid-phase; a plurality of manifolds including: a first manifold which defines a first internal cavity, the first manifold including a first fluid inlet including a liquid feed inlet, a second fluid inlet including a first liquid mobile phase inlet, a first substrate inlet, and a first substrate outlet; a second manifold which defines a second internal cavity, the second manifold including a second fluid inlet including a liquid wash inlet, a second substrate inlet, and a second substrate outlet; a third manifold which defines a third internal cavity, the third manifold including a third fluid outlet including a first component outlet, a third substrate inlet, and a third substrate outlet; and a fourth manifold which defines a fourth internal cavity, the fourth manifold including a fourth fluid outlet including a second component outlet, a fourth substrate inlet, and a fourth substrate outlet; a plurality of manifold-interconnecting-conduits (MICs) including: a first MIC which connects the first substrate outlet of the first manifold to the second substrate inlet of the second manifold; a second MIC which connects the second substrate outlet of the second manifold to the third substrate inlet of the third manifold; a third MIC which connects the third substrate outlet of the third manifold to the fourth substrate inlet of the fourth manifold; and a fourth MIC which connects the fourth substrate outlet of the fourth manifold to the first substrate inlet of the first manifold; and a pulley system which defines a substrate-travel path passing through each of the plurality of manifolds and which includes: an in-line tensioner housed within at least one of the plurality of manifolds and configured to be connected to a drive motor; and a respective idler pulley housed within each of at least a portion of the remaining plurality of manifolds, wherein the substrate is supported by the pulley system and travels along the substrate-travel path, and the substrate-travel path includes or forms a continuous loop.

In another aspect, example embodiments provide a method for the abovementioned system and, more particularly, a method of, for example, separating one or more components in a liquid feed. The method may include the following: (i) providing a CCS as described and disclosed herein; (ii) supplying the liquid feed via the liquid feed inlet of the first manifold, wherein the liquid feed includes a first component and a second component; (iii) supplying a first liquid mobile phase via the first liquid mobile phase inlet, wherein the liquid feed and the first liquid mobile phase admix and pass from the first manifold into the fourth MIC; (iv) conveying the substrate along the substrate-travel path, wherein a first wet zone between the first manifold and the fourth manifold defines an enrichment zone where the first component and a second component of the liquid feed are at least partially separated, and wherein the first component is selectively enriched on the substrate, and wherein the substrate-travels countercurrent to the direction of the first liquid mobile phase passing from the first manifold to the fourth manifold via the fourth MIC; (v) supplying a liquid wash via the liquid wash inlet of the second manifold; wherein the liquid wash passes from the second manifold, through the second MIC, and into the third manifold, and wherein the liquid wash desorbs at least a portion of the first component enriched on the substrate; (vi) removing a first product stream including an enriched concentration of the first component via the first component outlet of the third manifold; and (vii) removing a second product stream including an enriched concentration of the second component from the second component outlet of the fourth manifold. In accordance with example embodiments, steps (ii)-(vii) may be performed simultaneously and/or continuously. In this egard, a continuous feed stream and continuous first and second product streams may beneficially be realized.

### BRIEF DESCRIPTION OF THE DRAWINGS

The above and other aspects, features, and advantages will become more readily apparent from the detailed description, accompanied by the drawings, in which like numbers refer to like elements throughout, and wherein:

FIG. 1 is a schematic of a continuous chromatography system (CCS) according to example embodiments;

FIG. 2 is a schematic of a CCS according to example embodiments; and

FIG. 3 is a schematic of a CCS in operation with a feed stream including a mixture of Allura Red AC dye and methylene blue dye according to one example embodiment.

### DETAILED DESCRIPTION

Non-limiting, example embodiments will now be described more fully with reference to the accompanying drawings, in which some, but not all embodiments of the invention are shown and in which like numbers refer to like elements throughout. This invention may also be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

Example embodiments relate generally to a continuous chromatography system (CCS) that utilizes a continuously moving solid phase. The continuously moving solid phase may include a single or unitary element as opposed to the traditional use of a plurality of fine resinous beads, which are typically packed as a bed in batch chromatography or simulated moving bed (SMB) chromatography. By way of example only, the continuously moving solid phase may include a structure having a rope or rope-like structure, or a belt or a belt-like structure. The continuously moving solid phase may be driven or passed through a plurality of separate manifolds of the CCS, in which each manifold may include respective internal cavities through which the continuously moving solid phase passes. The manifolds may also include one or more respective inlet and/or outlet ports in fluid communication with corresponding internal cavities. For example, a first manifold may include two inlet ports for the addition of a liquid feed stream, which may include two or more components/constituents (e.g., a first chemical compound, and a second chemical compound) mixed therein, and for the addition of a liquid mobile phase stream. In this regard, each of these liquid input streams become admixed or otherwise become intimately admixed with each other within the CCS and brought into intimate contact with the continuously moving solid phase. In this regard, the admixture of the liquid feed stream and the liquid mobile phase is allowed to exit the first manifold, such as due to gravitational flow, and pass through a manifold-interconnecting-conduits (MIC) connecting the first manifold to a fourth manifold. The continuously moving solid phase travels in a path and/or direction that is opposite to that of the admixture of the liquid feed stream and the liquid mobile phase stream. That is, the continuously moving solid phase travels in a path that is countercurrent to the flow of the admixture of the liquid feed stream and the liquid mobile phase through, at least, the MIC connecting the first and fourth manifolds. This countercurrent condition between the continuously moving solid phase and the liquid feed/mobile phase stream may be considered as an enrichment zone where, for example, a first component having a higher affinity for the solid phase is selectively enriched onto the solid phase while a second component having a lower affinity for the solid phase remains at least predominantly in the mobile phase. As such, two concentration gradients may be established along the enrichment zone located between the first and fourth manifolds. For instance, a first concentration gradient for the first component, which has a higher affinity for the solid phase, has a higher relative concentration of the first component (relative to the original concentration of the first component in the incoming liquid feed stream) proximate the first manifold as compared to a location proximate the fourth manifold as described in more detail later. The second concentration gradient for the second component, which has a lower affinity for the solid phase, has a higher relative concentration of the second component (relative to the original concentration of the second component in the incoming liquid feed stream) proximate the fourth manifold as described in more detail later. In this regard, the first component may be selectively enriched onto the solid phase, while the second component may be selectively enriched into the mobile phase and may be removed from the CCS via an outlet port, for example, located at the fourth manifold.

The continuously moving solid phase, which may be selectively enriched with at least a first component of the liquid feed stream, may exit the first manifold and be conveyed or passed into a second manifold having a liquid wash stream introduced thereto. The liquid wash stream is brought into intimate contact with the solid phase and is allowed to flow in a co-current configuration with the traveling solid phase from the second manifold to a third manifold via a MIC connecting the second and third manifolds. In this regard, this co-current condition between the continuously moving solid phase and the liquid wash stream may be considered as a desorption zone where, for example, the first component is released or washed off of the continuously moving solid phase and removed from the CCS via a liquid outlet port of the third manifold. In this regard, a first component-enriched liquid product stream may be withdrawn from the fourth manifold. For example, the purity of this product stream with respect to the first component is increased as the relative amount of the second component has been reduced (or eliminated). By way of example, only, the liquid feed steam could have a mass ratio between the first component of and the second component of 1:1, while the product stream from the fourth manifold could have a mass ratio between the first component and the second component of 3:1 to 99:1, such as at least about any of the following: 3:1, 4:1, and 5:1, and/or at most about any of the following: 99:1, 19:1, 9:1, 6:1, and 5:1. In this regard, the liquid product stream exiting the CCS via the fourth manifold may be selectively enriched with the first component from the liquid feed stream.

In this regard, the continuously moving solid phase may exit the third manifold and be conveyed or passed from the third manifold to the fourth manifold defining a continuous loop of travel through each of the manifolds of the CCS. In this regard, the continuously moving solid phase may be considered at least partially, mostly, or completely regenerated by removal of most (or all) of the first component and/or the second component. In some embodiments, however, a residual amount of the first component and/or the second component may possible remain on the continuously traveling solid phase.

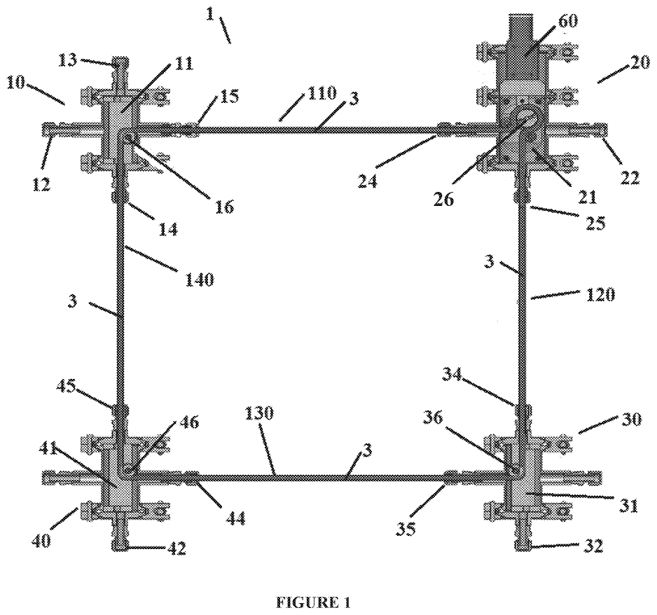

In accordance with some example embodiments, each manifold may include a respective substrate inlet and substrate outlet. For example, the first manifold and the third manifold may be oriented horizontally with respect to each other, and the fourth manifold and the third manifold may be oriented horizontally with respect to each other, while the first manifold and the fourth manifold are oriented vertically with respect to each other and the second manifold and the third manifold may be oriented vertically with respect to each other. In this regard, an overall liquid flow downward/vertical flow (e.g., from the first manifold to the fourth manifold, and from the second manifold to the fourth manifold) of fluid with in the CCS is promoted. In this regard, the substrate inlets/outlets aligned in the horizontal direction (e.g., first substrate outlet, second substrate inlet, the third substrate outlet, and the fourth substrate inlet) may include a seal housed therein, which imparts an smaller free-flow are between the internal diameter of the substrate input/outlet and the substrate compared to the vertically aligned substrate inlets/outlets (e.g., the first substrate inlet, the fourth substrate outlet, the second substrate outlet, and the fourth substrate inlet). FIG. 1-3, as discussed below, provide a more clear illustration of the substrate inlets/outlets having the seal and/or reduced free-flow area to facilitate downward flow. In this regard, the differential free-flow area biases any fluid in the CCS to flow downward (e.g., from up to down in FIGS. 1-3) as opposed to horizontally (e.g., from left right or vice versa in FIGS. 1-3).

In this regard, example embodiments provide a continuous chromatography system (CCS) including: (i) a substrate defining a solid-phase, wherein the substrate includes a continuous loop; (ii) a plurality of manifolds including: (a) a first manifold defining a first internal cavity, the first manifold including a first fluid inlet including a liquid feed inlet, a second fluid inlet including a first liquid mobile phase inlet, a first substrate inlet, a first substrate outlet; (b) a second manifold defining a second internal cavity, the second manifold including a second fluid inlet including a liquid wash inlet, a first substrate inlet, a first substrate outlet; (c) a third manifold defining a third internal cavity, the third manifold including a third fluid outlet including first component outlet, a third substrate inlet, a third substrate outlet; and (d) a fourth manifold defining a fourth internal cavity, the fourth manifold including a fourth fluid outlet including second component outlet, a fourth substrate inlet, a fourth substrate outlet; (iii) a plurality of manifold-interconnecting-conduits (MIC) including: (a) a first MIC operatively connecting the first substrate outlet of the first manifold to the second substrate inlet of the second manifold; (b) a second MIC operatively connecting the second substrate outlet of the second manifold to the third substrate inlet of the third manifold; (c) a third MIC operatively connecting the third substrate outlet of the third manifold to the fourth substrate inlet of the fourth manifold; and (d) a fourth MIC operatively connecting the fourth substrate outlet of the fourth manifold to the first substrate inlet of the first manifold; and (iv) a pulley system defining a substrate-travel path passing through each of the plurality of manifolds, and the pulley system includes (a) an in-line tensioner housed within at least one of the plurality of manifolds and being configured to be operatively connected to a drive motor, and (b) a respective idler pulley housed within each of at least a portion of the remaining plurality of manifolds, and optionally (c) a drive pulley configured to be operatively connected to the drive motor if the in-line tensioner is not operatively connected to the drive motor. In this regard, when the in-line tensioner is operatively connected to a drive motor, a separate drive pulley is not required. As such, each manifold not housing the in-line tensioner may include an idler pulley to facilitate movement of the substrate through each of the manifolds in a repeated “loop”. In this regard, the substrate may be supported by the pulley system and travel along the substrate-travel path (e.g., through each of the manifolds in a countercurrent manner relative to the flow of mobile phase from the first manifold towards the fourth manifold).

FIG. 1 illustrates a schematic of a CCS 1 according to some example embodiments. The CCS 1 includes a continuous substrate (e.g., solid phase) 3 that travels in a continuous loop through a first manifold 10, a second manifold 20, a third manifold 30, a fourth manifold 40 and back to the first manifold 10. The CCS also includes a first MIC 110 operatively connecting the first manifold 10 to the second manifold 20, wherein the substrate 3, which may define a solid-phase or state for the CCS system, travels (or extends) through the entirety of the first MIC. Similarly, the CCS includes a second MIC 120 operatively connecting the second manifold 20 and the third manifold 30, in which the substrate 3 travels (or extends) through the entirety of the second MIC. Still further, the CCS includes a third MIC 130 operatively connecting the third manifold 30 and the fourth manifold 40, wherein the substrate 3 travels (or extends) through the entirety of the third MIC. Also, the CCS includes a fourth MIC 140 operatively connecting the fourth manifold 40 and the first manifold 10, wherein the substrate 3 travels (or extends) through the entirety of the fourth MIC.

FIG. 1 also illustrates features of each manifold of the CCS. For instance, the first manifold 10 includes a first internal cavity 11, a first fluid inlet including a liquid feed inlet 12, a second fluid inlet including a first liquid mobile phase inlet 13, a first substrate inlet 14, and a first substrate outlet 15. In this regard, during operation of the CCS the substrate 3 enters the first manifold 10 via the first substrate inlet 14, passes through the first internal cavity 11, and exits the first manifold 10 via the first substrate outlet 15. Similarly, the second manifold 20 may include or define a second internal cavity 21, a second fluid inlet including a liquid wash inlet 22, a second substrate inlet 24, and a second substrate outlet 25. In this regard, during operation of the CCS the substrate 3 enters the second manifold 20 via the second substrate inlet 24, passes through the second internal cavity 21, and exits the second manifold 20 via the second substrate outlet 25. Similarly, the third manifold 30 may include or define a third internal cavity 31, a third fluid outlet including a third component outlet 32, a third substrate inlet 34, and a third substrate outlet 35. In this regard, during operation of the CCS the substrate 3 enters the third manifold 30 via the third substrate inlet 34, passes through the third internal cavity 31, and exits the third manifold 30 via the third substrate outlet 35. Still further, the fourth manifold 40 may include or define a fourth internal cavity 41, a fourth fluid outlet including a fourth component outlet 42, a fourth substrate inlet 44, and a fourth substrate outlet 45. In this regard, during operation of the CCS the substrate 3 enters the fourth manifold 40 via the fourth substrate inlet 44, passes through the fourth internal cavity 41, and exits the fourth manifold 40 via the fourth substrate outlet 45. In this regard, the substrate (e.g., solid phase) travels through (or extends through) each of the manifolds and each of the MICs.

As also illustrated in FIG. 1, the CCS includes a pulley system including one or more idler pulleys and a tensioner. In accordance with some example embodiments, the tensioner may double as a drive pulley. That is, the tensioner 26 may be configured or actually operatively coupled to a drive motor for driving the substrate 3 through a substrate-travel path (e.g., through each of the manifolds and MICs). In embodiments in which the tensioner is not operatively coupled or capable of being operatively coupled to a drive motor, one of the manifolds may house a drive pulley therein. However, the embodiments illustrated by FIG. 1 include an in-line tensioner 26 operatively coupled to a drive motor 60. As also illustrated by FIG. 1, each manifold includes a respective idler pulley 16, 36, 46. In such embodiments as illustrated by FIG. 1, the in-line tensioner 26 is operatively connected to a drive motor 60 so a separate drive pulley is not required. As such, each manifold not housing the in-line tensioner may include an idler pulley to facilitate movement of the substrate through each of the manifolds in a repeated “loop”.

In accordance with some example embodiments, the substrate (e.g., defining a single and/or unitary solid phase for the CCS) may be embodied as a rope. The nature of the rope may be selected for various separation applications. For instance, ropes according to example embodiments may be constructed from materials for which one of the constituents of a feed stream or sample has a natural affinity and/or tensile strength to ensure or mitigate against breakage during operation where the substrate will be under applied tension as it travels through the CCS.

As noted above, the substrate may include a single or unitary structure. In this regard, the structure (e.g., rope) may be self-bonded to itself. That is, a first end of the structure may be thermally bonded to a second end of the substrate to define the continuous “loop”. Additionally or alternatively, the substrate may include a coupler, such as a mechanical coupler and/or an adhesive, that connects two ends of the substrate to define the continuous “loop”.

In accordance with some example embodiments, the substrate (e.g., a rope) may include natural fibers, synthetic fibers, or a combination thereof. By way of non-limiting example, for instance, the natural fibers may include manila, sisal, cotton, hemp, jute, or any combination thereof. By way of non-limiting example, for instance, the synthetic fibers include a polyamide, a polypropylene, a polyester, a polyethylene, or any combination thereof. By way of further example, the polyamide may include synthetic polymers such as nylon 6, nylon 66, an aromatic polyamide (e.g., KEVLAR®), or any combination thereof.

In accordance with some example embodiments, the substrate may include a rope having a twisted rope, a braided rope, or plaited rope. In this regard, the physical structure of the rope may be selected based on average porosity and/or surface area of the rope, wherein one particular structural configuration (e.g., twisted, braided, etc.) may provide a more desirable solid phase for a given separations application.

The substrate (e.g., a rope), in accordance with some example embodiments, may have an average external diameter in a relaxed state (e.g., the rope is free from any external tension) and/or in a dry state having a certain value. In this regard, at least one or the plurality of MICs (or all) may have an internal diameter that is equal to or greater than the average external diameter of the rope in the relaxed and/or dry state. For example, a ratio between the internal diameter of the MIC(s) and the average diameter of the rope in the relaxed and/or dry state may be from 1:1 to 2:1, such as at least about any of the following: 1:1, 1.1:1, 1.2:1, 1.3:1, 1.4:1, and 1.5:1, and/or at most about any of the following: 2:1, 1.9:1, 1.8:1, 1.7:1, 1.6:1, and 1.5:1. In accordance with some example embodiments, a free-flow area located between the external surface of the substrate and the internal surface of the MIC(s) is limited. In this regard, the mobile phase and liquid wash are forced to interact more thoroughly with the substrate and promote improved enrichment and desorption, respectively.

In accordance with some example embodiments, the substrate is selected or configured for normal phase chromatography (e.g., the substrate has a polar nature and the mobile phase may be generally less polar in nature than the substrate). Alternatively, the substrate is selected or configured for reverse phase chromatography (e.g., the substrate has a non-polar nature and the mobile phase may be generally more polar than the substrate).

The substrate, in accordance with some example embodiments, may be functionalized with one or more polarity increasing groups or one more polarity decreasing groups. In this regard, the substrate may be modified from an original for by bonding one or more functional groups thereto, in which the added functional groups are selected for a particular separations/purification application. For example, the substrate may be functionalized with a C8 (octyl)-C18 (octadecyl) functional group and/or a cyano group and/or an aromatic functional group, and/or a diol functional group and/or an amino acid and/or an enzyme and/or a metabolite.

As noted above, the chemical and/or physical nature of the substrate may not be particularly limited, and can be tailored for a given separation and/or purification need without departing from the spirit of the present invention.

As also noted above, each of the manifolds may include or define a respective internal cavity. For instance, the first internal cavity of the first manifold may define or function as a mixing chamber wherein a liquid feed from the liquid feed inlet is fluidly mixed with a first mobile phase from the first liquid mobile phase inlet. In accordance with some example embodiments, the liquid feed inlet enters that first internal cavity at a feed location that is below a mobile phase entry location where the first mobile phase enters the first internal cavity. In this regard, the feed location may be located closer to the first substrate inlet than the mobile phase entry location. Additionally or alternatively, the feed location may be located below the first substrate outlet in a z-direction (e.g., z-direction being perpendicular to an x-y plane such as a flooring where an operator stands).

In accordance with some example embodiments, the CCS may include a support structure upon with each of the plurality of manifolds are directly or indirectly mounted onto. Additionally or alternatively, the first manifold may be mounted above the fourth manifold in a z-direction (e.g., z-direction being perpendicular to an x-y plane such as a flooring where an operator stands) and/or the second manifold may be mounted above the third manifold in a z-direction (e.g., z-direction being perpendicular to an x-y plane such as a flooring where an operator stands). In this regard, the respective liquid fluids entering the first and second manifolds may flow towards the fourth and third manifolds, respectively, due at least in part to gravitational flow.

As referenced above, the CCS may include or define a first wet zone (e.g., first actively wet zone), located between the first manifold and the fourth manifold and defining an enrichment zone wherein a first component and a second component of a liquid feed are at least partially separated. For instance, upon operation the first component may be electively enriched on the substrate and the second component may be selectively allowed to exit the CCS via the fourth fluid outlet including the second component outlet. The first wet zone (e.g., first actively wet zone), in this regard, includes the region in which the admixture of the liquid feed and the first liquid mobile phase flow from the first manifold to the fourth manifold.

As also referenced above, the CCS may include or define a second wet zone (e.g., second actively wet zone), located between the second manifold and the third manifold and defining a wash zone wherein the first component from the liquid feed is washed off of the substrate and allowed to exit the CCS via the third fluid outlet including the first component outlet. The second wet zone (e.g., second actively wet zone), in this regard, includes the region in which the liquid wash flows from the second manifold to the third manifold.

The CCS, as noted above, may include an in-line tensioner, which may be housed in any of the manifolds. FIG. 1, as noted above, illustrates the location of the in-line tensioner 26 being housed within the second manifold 20. The in-line tensioner may be configured to maintain a constant tension on the substrate during operation wherein the substrate is conveyed along the substrate-travel path as described throughout. Additionally or alternatively, each of the first manifold, the third manifold, and the fourth manifold include a respective idler puller housed therein. The idler pulleys help guide and change the direction of travel of the substrate throughout the CCS. The idler pulleys, for instance, also help reduce frictional forces acting on the substrate at locations of directional change.

In accordance with some example embodiments, the CCS is a hermetically sealed system. In this regard, the CCS may be rated for operation at elevated internal operating pressures, such as from at about 1 to about 40 psi, such as at least about any of the following: 1, 3, 5, 8, 10, 12, 15, 18, and 20 psi, and/or at most about any of the following: 40, 38, 35, 32, 30, 28, 25, 22, and 20 psi. Additionally or alternatively, one or more of the plurality of manifolds, and/or one or more of the MICs may be thermally insulated and/or include a heat-supplying source configured to increase and/or maintain a desired average operating temperature within the CCS. For example, the heat-supplying means may include one or more electrical heater and/or one or more shell structures encasing at least a portion of the CCS, wherein the one or more shell structures being operatively connected to a heat-providing working fluid, such as steam.

In accordance with some example embodiments, the CCS may further include a liquid feed supply system including a liquid feed in operative communication with the liquid feed inlet of the first manifold. Additionally, the CCS may further include a first mobile phase supply system including a first mobile phase in operative communication with the first liquid mobile phase inlet of the first manifold. Additionally, the CCS may further include a liquid wash supply system including a liquid wash in operative communication with the liquid wash inlet of the second manifold.

In another aspect, some example embodiments provide a method of separating one or more components in a liquid feed. The method may include the following: (i) providing a CCS as described and disclosed herein; (ii) supplying the liquid feed via the liquid feed inlet of the first manifold, wherein the liquid feed includes a first component and a second component; (iii) supplying a first liquid mobile phase via the first liquid mobile phase inlet, wherein the liquid feed and the first liquid mobile phase admix and pass from the first manifold into the fourth MIC; (iv) conveying the substrate along the substrate-travel path, wherein a first wet zone between the first manifold and the fourth manifold defines an enrichment zone where the first component and a second component of the liquid feed are at least partially separated, and wherein the first component is selectively enriched on the substrate, and wherein the substrate-travels countercurrent to the direction of the first liquid mobile phase passing from the first manifold to the fourth manifold via the fourth MIC; (v) supplying a liquid wash via the liquid wash inlet of the second manifold; wherein the liquid wash passes from the second manifold, through the second MIC, and into the third manifold, and wherein the liquid wash desorbs at least a portion of the first component enriched on the substrate; (vi) removing a first product stream including an enriched concentration of the first component via the first component outlet of the third manifold; and (vii) removing a second product stream including an enriched concentration of the second component from the second component outlet of the fourth manifold. In accordance with some example embodiments, steps (ii)-(vii) may be performed simultaneously and/or continuously. In this regard, a continuous feed stream and continuous first and second product streams may beneficially be realized.

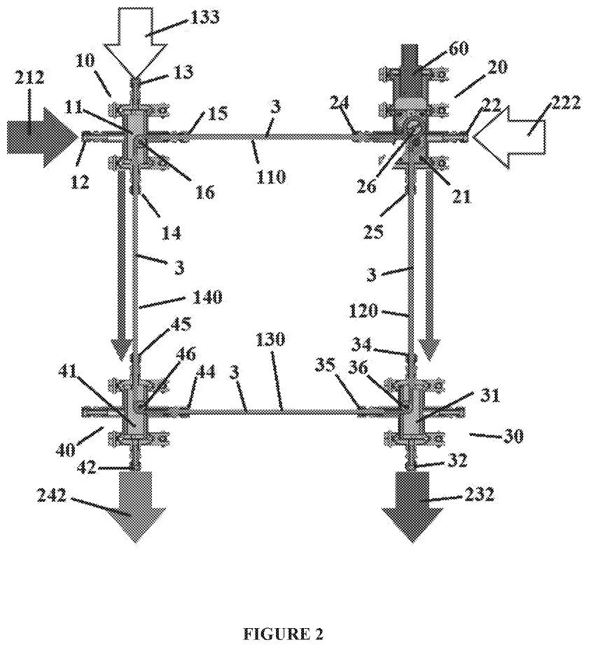

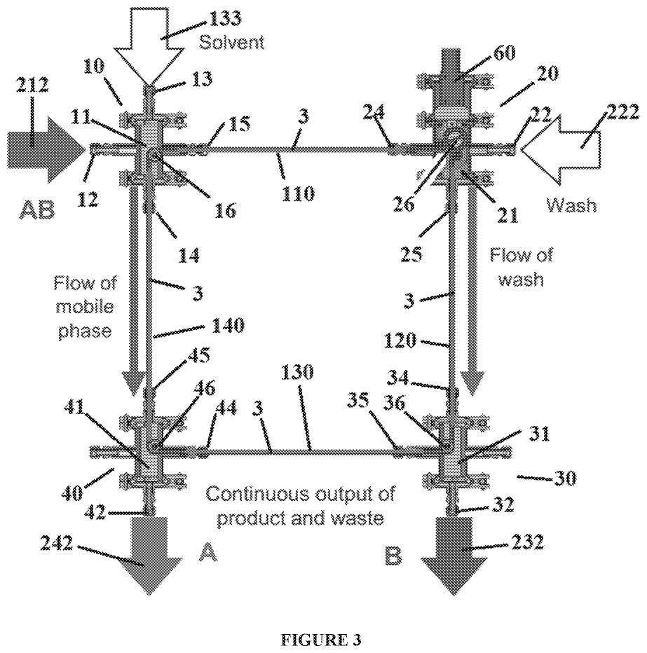

FIG. 2 is a schematic of a CCS 1 in according to some example embodiments and FIG. 3 is a schematic of the CCS 1 shown in FIG. 2 in operation with a feed stream including a mixture of Allura Red AC dye and methylene blue dye according to one example embodiment. As shown in FIGS. 2 and 3, for instance, a continuous liquid feed stream 212 including a first component (i.e., “A”) and a second component (i.e., “B”). The liquid feed stream 212 enters the first manifold 10 via the first liquid feed inlet 12. Similarly, a first liquid mobile phase stream 133 also (and simultaneously with the liquid feed stream) enters the first manifold 10, but via the first liquid mobile phase inlet 13. Simultaneously, a liquid wash stream 222 enters the second manifold 20 via the liquid wash inlet 22 and the substrate 3 is driven and circulates continuously through each of the manifolds 10, 20, 30, 40 and each of the MICs 110, 120, 130, 140. The liquid feed stream 212 and the first liquid mobile phase stream 133 may admix within the first internal cavity 11 of the first manifold 10, and flow downwardly towards the fourth manifold 40 by exiting the first manifold 10 via the first substrate inlet 14, through the fourth MIC 140, and into the fourth manifold via the fourth substrate outlet 45. As illustrated in FIG. 2 and discussed throughout, the substrate 3 travels in an opposite direction than the flow of the first mobile phase, such that a countercurrent configuration between (i) the admixture of the liquid feed stream and the first mobile phase stream, and (ii) the substrate. In a similar manner, the liquid wash stream exits the second manifold 20 via the second substrate outlet 25 and travels downwardly through the second MIC 120 and into the third manifold 30 via the third substrate inlet 34. It is noted, however, that the substrate 3 travels in a co-current configuration with the flow of the liquid wash. FIGS. 2 and 3, in this regard, illustrates that the substrate travels in a clockwise manner through the CCS. As also, illustrated by FIG. 2, a first product stream 232 including an enriched concentration of the first component (i.e., “A”) via the first component outlet 32 of the third manifold 30 may be established for the continuous collection of the first product stream 232. Similarly, a second product stream 242 including an enriched concentration of the second component (i.e., “B”) from the second component outlet 42 of the fourth manifold 40 may be established for the continuous collection of the second product stream 242. It should be noted that the use of the term “product stream” may also include a stream enriched with impurities, such as for purification applications of the CCS. In accordance with some example embodiments, the addition and removal of these liquid streams may be performed simultaneously and/or continuously. In this regard, a continuous feed stream and continuous first and second product streams may beneficially be realized.

In accordance with some example embodiments, the method includes adjusting a feed flow rate (e.g., volume per unit time) of the liquid feed based upon a measured concentration and/or a measured purity of the first component present in the first product stream and/or a measured concentration of the first component in the second product stream. For example, if the concentration and/or purity of the first product stream for the first component is below a desired value, one or more process variables may be adjusted, for example, to increase a residence time in the enrichment zone as described above. Similarly, the purity value of the first product stream may be desirable, but some of the first component may undesirably be exiting the CCS via the second product stream. In this regard, one or more process variables may be adjusted, for example, to increase a residence time in the enrichment zone as described above. For example, an excessively high feed rate for a given set of operating parameters may result in the substrate reaching a saturation-point for the first component, such that any additional first component with the enrichment zone cannot effectively attach to the substrate and consequently exit the CCS via the second product stream.

Additionally or alternatively, the method may include adjusting a first mobile phase flow rate of the first liquid mobile phase based upon a measured concentration and/or a measured purity of the first component present in the first product stream and/or a measured concentration of the first component in the second product stream. For example, if an insufficient first mobile phase flow rate is utilized, the second component may not be adequately carried towards the fourth manifold and out via the second product stream. In such a scenario, the substrate may undesirable retain a level of the second component after exiting the first manifold and result in the second component (e.g., “B” in FIG. 3) being washed out/off the substrate via the liquid wash in the desorption zone of the CCS. This scenario would result in an undesirable level of the second component (e.g., “B” in FIG. 3)being present in the first product stream (e.g., 232 in FIG. 3).

Additionally or alternatively, the method may include adjusting a substrate velocity of the substrate based upon a measured concentration and/or a measured purity of the first component present in the first product stream and/or a measured concentration of the first component in the second product stream. In this regard, the substrate velocity may play a role in the residence time that the substrate is present in the enrichment zone, in which the liquid feed and the first mobile phase are brought into intimate and countercurrent contact with the substrate. Accordingly, an excessively fast substrate velocity for a given set of operating parameters may results in an insufficient time for the selective separation of the first component (e.g., “A” in FIG. 3) and the second component (e.g., “B” in FIG. 3). Accordingly, identification of an undesirable amount of the second component in the first product stream (e.g., 232 in FIG. 3) may indicate a need for lowering the substrate velocity.

Additionally or alternatively, the method may include adjusting a liquid wash flow rate of the liquid feed based upon a measured concentration and/or a measured purity of the first component present in the first product stream and/or a measured concentration of the first component in the second product stream. For instance, a sufficient liquid wash flow rate may be needed to adequately capture and/or remove all of the first component (e.g., “A” in FIG. 3) for removal as the first product stream (e.g., 232 in FIG. 3). An insufficient liquid wash flow rate, for instance, may result in insufficient removal of the first component and the substrate will carry the unremoved first component back into the enrichment zone. This scenario may lead to an early saturation of the substrate for the first component in the enrichment zone and eventually an undesirable loss of the first component (e.g., “A” in FIG. 3) via the second product stream (e.g., 242 in FIG. 3).

Additionally or alternatively, the method may include adjusting an internal operating pressure and/or internal operating temperature within the CCS based upon a measured concentration and/or a measured purity of the first component present in the first product stream and/or a measured concentration of the first component in the second product stream. In this regard, the internal operating pressure and/or temperature may facilitate the selective enrichment of the first component on the substrate.

Accordingly, any combination of the foregoing variables may be adjusted either alone or in any combination until the desired compositional thresholds for the first and second product streams are realized.

By way of example only, upon detection of a concentration of the first component (e.g., “A” in FIG. 3) in the second product stream (e.g., 242 in FIG. 3) being above a threshold value, the method may include increasing a residence time between the feed stream and the substrate in the enrichment zone. For example, the feed flow rate and/or the substrate velocity may be adjusted to provide a longer time of interaction between the components present in the liquid feed and the substrate (e.g., increase a residence time in the enrichment zone). For instance, increasing the residence time between the feed stream and the substrate in the enrichment zone may include reducing the substrate velocity of the substrate traveling through the CCS and/or reducing a feed flow rate of the liquid feed and/or reducing a first mobile phase flow rate of the first liquid mobile phase.

Although noted above, the first component (e.g., “A” in FIG. 3) may have a first affinity for the substrate and the second component (e.g., “B” in FIG. 3) may have a second affinity for the substrate, in which the first affinity for the substrate is larger than the second affinity for the substrate. In this regard, the first component may be selectively retained by the substrate while the second component may more readily pass the substrate for removal via the second product stream (e.g., 242 in FIG. 3).

In accordance with some example embodiments, the first liquid mobile phase and the liquid wash may have different polarity values and/or different pH values to facilitate the selective enrichment of the first component (e.g., “A” in FIG. 3) in the enrichment zone and the subsequent removal of the first component from the substrate in the desorption zone.

### EXAMPLES

The present disclosure is further illustrated by the following examples, which in no way should be construed as being limiting. That is, the specific features described in the following examples are merely illustrative and not limiting.

Returning again to FIG. 3, which is a schematic of a CCS in operation with a feed stream including a mixture of Allura Red AC (FD&C Red 40) dye and methylene blue (methylthioninium chloride) dye according to example embodiments, the liquid feed steam 122 contained 50% of Allura Red AC (arrow “A” in FIGS. 3) and 50% of methylene blue (arrow “B” in FIG. 3). The CCS was operated at room temperature, while the substrate in this example was a polypropylene rope. The first liquid mobile phase (e.g., the solvent 133 in FIG. 3) was pH 10 buffered D.I. water and 10% methanol (MeOH), while the liquid wash (232) was pH 1 buffered D.I. water and 10% MeOH. In this regard, a variety of different operating parameters have been tested at various steady state conditions as summarized below:
First Liquid Mobile Phase Flow Rate=100-500 ml/min.
Liquid Wash Flow Rate=100-500 ml/min.
First Product Flow Rate=10-40 ml/min.
Second Product Flow Rate=10-40 ml/min.
Operating Pressure=25 psi.

Generally, the first product stream 232 contained about 30% of Allura Red AC and 70% of Methylene Blue.

The second product stream 242 contained about 70% of Allura Red AC and 30% of Methylene Blue

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein

That which is claimed is:

1. A continuous chromatography system (CCS), comprising:
a substrate which defines a solid-phase;
a plurality of manifolds comprising:
a first manifold which defines a first internal cavity, the first manifold including a first fluid inlet comprising a liquid feed inlet, a second fluid inlet comprising a first liquid mobile phase inlet, a first substrate inlet, and a first substrate outlet;
a second manifold which defines a second internal cavity, the second manifold including a second fluid inlet comprising a liquid wash inlet, a second substrate inlet, and a second substrate outlet;
a third manifold which defines a third internal cavity, the third manifold including a third fluid outlet comprising a first component outlet, a third substrate inlet, and a third substrate outlet; and
a fourth manifold which defines a fourth internal cavity, the fourth manifold including a fourth fluid outlet comprising a second component outlet, a fourth substrate inlet, and a fourth substrate outlet;
a plurality of manifold-interconnecting-conduits (MICs) including:
a first MIC which connects the first substrate outlet of the first manifold to the second substrate inlet of the second manifold;
a second MIC which connects the second substrate outlet of the second manifold to the third substrate inlet of the third manifold;
a third MIC which connects the third substrate outlet of the third manifold to the fourth substrate inlet of the fourth manifold; and
a fourth MIC which connects the fourth substrate outlet of the fourth manifold to the first substrate inlet of the first manifold; and
a pulley system which defines a substrate-travel path passing through each of the plurality of manifolds and which includes:
an in-line tensioner housed within at least one of the plurality of manifolds and configured to be connected to a drive motor; and
a respective idler pulley housed within each of at least a portion of the remaining plurality of manifolds,
wherein the substrate is supported by the pulley system and travels along the substrate-travel path, and
the substrate-travel path comprises or forms a continuous loop.

2. The CCS of claim 1, wherein the substrate comprises a rope.

3. The CCS of claim 2, wherein the rope comprises natural fibers, synthetic fibers, or a combination thereof.

4. The CCS of claim 3, wherein the synthetic fibers comprise a polyamide, a polypropylene, a polyester, a polyethylene, or any combination thereof.

5. The CCS of claim 2, wherein the rope has an average diameter in a relaxed state, and at least one or the plurality of MICs have an internal diameter that is equal to or greater than the average diameter of the rope in the relaxed state.

6. The CCS of claim 5, wherein a ratio between the internal diameter of the MIC(s) and the average diameter of the rope in the relaxed state is from 1:1 to 2:1.

7. The CCS of claim 1, wherein the first internal cavity of the first manifold defines a mixing chamber wherein a liquid feed from the liquid feed inlet is fluidly mixed with a first mobile phase from the first liquid mobile phase inlet.

8. The CCS of claim 1, wherein the liquid feed inlet enters that first internal cavity at a feed location that is below a mobile phase entry location where the first mobile phase enters the first internal cavity, wherein the feed location is located closer to the first substrate inlet than the mobile phase entry location.

9. The CCS of claim 8, wherein the feed location is located below the first substrate outlet in a z-direction.

10. The CCS of claim 1, further comprising a support structure upon which each of the plurality of manifolds are directly or indirectly mounted onto, and wherein (i) the first manifold is mounted above the fourth manifold in a z-direction, and (ii) the second manifold is mounted above the third manifold in a z-direction.

11. The CCS of claim 10, wherein a first wet zone between the first manifold and the fourth manifold defines an enrichment zone wherein a first component and a second component of a liquid feed are at least partially separated, wherein upon operation the first component is selectively enriched on the substrate and the second component selectively allowed to exit the CCS via the fourth fluid outlet comprising the second component outlet.

12. The CCS of claim 10, wherein a second wet zone between the second manifold and the third manifold defines a wash zone wherein the first component from the liquid feed is washed off of the substrate and allowed to exit the CCS via the third fluid outlet comprising the first component outlet.

13. The CCS of claim 1, wherein the in-line tensioner is housed within the second manifold.

14. The CCS of claim 13, wherein each of the first manifold, the third manifold, and the fourth manifold include a respective idler puller housed therein.

15. The CCS of claim 1, wherein the CCS is a hermetically sealed system.

16. The CCS of claim 1, wherein the plurality of MICs further includes a drive pulley operatively connected to the drive motor when the in-line tensioner is not operatively connected to the drive motor.

17. A method of separating one or more components in a liquid feed, the method comprising:
(i) providing a CCS of claim 1;
(ii) supplying the liquid feed via the liquid feed inlet of the first manifold, wherein the liquid feed includes a first component and a second component;
(iii) supplying a first liquid mobile phase via the first liquid mobile phase inlet, wherein the liquid feed and the first liquid mobile phase mix and pass from the first manifold into the fourth MIC;
(iv) conveying the substrate along the substrate-travel path, wherein a first wet zone between the first manifold and the fourth manifold defines an enrichment zone where the first component and a second component of the liquid feed are at least partially separated, and wherein the first component is selectively enriched on the substrate, and wherein the substrate travels countercurrent to a direction of the first liquid mobile phase passing from the first manifold to the fourth manifold via the fourth MIC;
(v) supplying a liquid wash via the liquid wash inlet of the second manifold; wherein the liquid wash passes from the second manifold, through the second MIC, and into the third manifold, and wherein the liquid wash desorbs at least a portion of the first component enriched on the substrate;
(vi) removing a first product stream comprising an enriched concentration of the first component via the first component outlet of the third manifold; and
(vii) removing a second product stream comprising an enriched concentration of the second component from the second component outlet of the fourth manifold.

18. The method of claim 17, wherein steps (ii)-(vii) are performed simultaneously and/or continuously.

19. The method of claim 18, wherein the method comprises adjusting at least one of (i) a feed flow rate of the liquid feed based, (ii) a first mobile phase flow rate of the first liquid mobile phase, (iii) a liquid wash flow rate of the liquid feed, and (iv) a substrate velocity of the substrate upon a measured concentration and/or a measured purity of the first component present in the first product stream and/or a measured concentration of the first component in the second product stream.

20. The method of claim 18, wherein upon detection of a concentration of the first component in the second product stream being above a threshold value, the method comprises increasing a residence time between the feed stream and the substrate in the enrichment zone.

21. The method of claim 20, wherein increasing the residence time between the feed stream and the substrate in the enrichment zone comprises reducing a substrate velocity of the substrate traveling through the CCS and/or reducing a feed flow rate of the liquid feed and/or reducing a first mobile phase flow rate of the first liquid mobile phase.
